(19) United States
(12) Patent Application Publication
(10) Pub. No.: US 2013/0046656 A1
(43) Pub. Date: Feb. 21, 2013

(54) Method and System for Navigation Free Online Payment

(71) Applicants: Pauli Koskelainen, Espoo (FI); Timo Helenius, Espoo (FI)

(72) Inventors: Pauli Koskelainen, Espoo (FI); Timo Helenius, Espoo (FI)

(73) Assignee: APE PAYMENT OY, Espoo (FI)

(21) Appl. No.: 13/514,980

(22) PCT Filed: Dec. 10, 2010
(86) PCT No.: PCT/IB10/03467

§ 371 Date: Sep. 17, 2012

Related U.S. Application Data
(60) Provisional application No. 61/285,532, filed on Dec. 10, 2009.

(51) Int. Cl. G06Q 20/12; G06Q 30/06

(52) U.S. Cl. 705/26.41

(57) ABSTRACT

A system and method of enabling a user to view online content from an online content provider, wherein the user accesses the online content provider on a browsing device over a communication network, has been disclosed in the invention. The online payment method comprising: requesting the online content from the online content provider by the user; sending an authentication request to the browsing device by the online content provider; sending a payment request to a payment system by the browsing device; processing the payment request by the payment system; sending a payment response to the browsing device; further transmitting the payment response to the merchant website; and displaying the online content on the browsing device based on the payment response.

### FIELD OF THE INVENTION

The invention relates in general to online the payment system and in particular, to method and system for a zero click online the payment system having no redirect page and no login requirement of recognizing a user and making a payment.

### BACKGROUND

Increased use of communication and Internet technology has altered the landscape of information delivery and has affected numerous aspects of life, including commerce and entertainment. This technological development has enabled individuals to participate in various business transactions within an Internet marketplace. In these online transactions, electronic payments between transacting parties have become increasingly prevalent as the accessibility of the technology to enable such payments has increased. Internet-based vendors typically depend on electronic payment services and may accept a number of electronic payment instruments (e.g., credit cards, debit cards, etc.) and other electronic payment services such as the PayPal™ online payment service. Conventionally, in an online identification and authorization system the user is required to provide his the user identification (ID)/user name, password, and personal details in order to purchase content from a website and/or gain access to content. Prior art systems all require this time consuming and cumbersome process of redirecting to a payment login screen requiring that a user recall a unique identified and password from among a large number of user-created online passwords and identifiers. This process is require for all sizes of payments, large or small (i.e. micropayments), and users may opt out of making a micropayment purchase in light of the tedium and difficulty presented by a typical log in process. The amount of time and aggravation involved in logging into a site typically outweighs purchasing goods of lesser value from and online merchant, especially when instant access to content is preferred, such as in the case of viewing up-to-the-minute news.

For example, in the AMAZON's 1-Click™ the payment system, the user initially creates a user account and specifies a credit card, shipping address, shipping method, and/or other default information to be used for 1-Click™ purchases, and can thereafter purchase items with a single mouse click. The 1-Click™ feature involves placing an identification cookie on the customer's computer. The customer's the web browser returns the cookie to the AMAZON web server when the website is accessed. The web server can then read the cookie to identify the customer and present to the customer a webpage providing the option of purchasing content. The user then takes affirmative action on a redirected confirmation page to “checkout” and pay for their purchases. However, this system requires that the user create and an AMAZON-specific login identity and login password on the micro payment server, which is a cumbersome process required in advance of purchasing a goods from only one specific website.

As mentioned above, with regard to buying inexpensive goods like online newspaper articles, groceries, books, musical compositions, or any other item whose value may be less than few dollars, a user might opt to engage with a micropayment systems. These systems help in reducing the operational costs associated with each transaction, regardless of the purchase price of the good or service, but they still rely on the cumbersome log in process typically associated with online accounts.

For example, PayPal™ enables a user to make payments and money transfers over the Internet without disclosing the user's credit card details or bank account details to an online merchant. However, the user is required to set a password and username for use with authorizing subsequent access to the PayPal™ system. Registering on PayPal™ and then providing the PayPal™ authorization details on each visit to a merchant site can be very cumbersome for a typical user who has to retain and recall many online account usernames and passwords.

All of these methods suffer from the time consuming process of creating an account on each site and remembering the password for each account.

Thus, a need exists for overcoming such tedious and burdensome processes of identifying and authorizing a payment, particularly a micropayment for making an instant purchase for goods or services offered on a merchant website.

### SUMMARY OF THE INVENTION

The present method provides a method and system for automatically and instantaneously identifying a user selecting content for sale on a merchant website and automatically authorizing online payment for the content without redirecting the webpage to a login in and/or purchase validation screen and with requiring any human intervention at all. The present invention therefore enables a user to purchase an item, in particular a relatively inexpensive item, online without the tedium and aggravation of recalling and providing a login or a password at a web interface and without being diverted away from viewing or downloading the desired content in order to administer a payment gateway webpage.

According to the present invention, the user accesses the merchant website over the Internet to buy an item online. In an embodiment of the invention, a user makes a purchase instantaneously by selecting a displayed link to the desired content. For example, on an online newspaper website, a user selects a news item for viewing by clicking on a hyperlinked headline. The action prompts a merchant website server hosting the content to automatically sends a request to the communication device (e.g. computer) of the user for authentication, which then transpires without the user's intervention and without any onscreen display of authentication. The authentication request is sent to a back end payment server in communication with the merchant website service and without the user having to navigate away from the main page of the website where the desired content is displayed for purchase. In response to selecting the content hyperlink, the user is simply presented with the news content without his knowledge of the various back end user identification and payment transactions.

The user payment is authorized by a payment system that verifies an identification cookie stored on the web browser of the browsing device (e.g. computer) of the user. Following verification of the identification cookie unique to the user's browsing device, the payment system automatically authenticates the payment and communicates same to the merchant website server. The payment system requires no intervention from the user, e.g. no on screen button clicks are required for completing the payment. The payment process is initiated and completed without any human intervention. The user need only choose the content to be read or the product to be bought from the merchant website offering the goods and services. The user is not required to provide any details like a user name (e.g. the user ID) or a password to access the payment system. During the payment process, the payment system processes the payment and communicates with the merchant web server and with the browsing device (e.g. the personal computer) of the user. During the payment process, the merchant webpage remains on display to the user without redirecting to a payment transaction page or any other page. After the payment transaction concludes, the web browser of the user's browsing device receives and displays notification of the completed payment.

### BRIEF DESCRIPTION OF THE DRAWINGS

FIG. 1 is a diagram which depicts the environment in which the invention may be practiced, according to an embodiment of the invention.

FIG. 2 is a diagram representing the system elements of the payment system, according to an embodiment of the invention.

FIG. 3 is a diagrammatic representation of the steps in which the method of online payment over the Internet is accomplished, according to an embodiment of the invention.

FIGS. 4A and 4B represent a flowchart depicting the method steps of practicing the invention according to an embodiment of the invention.

### DETAILED DESCRIPTION

The present invention discloses a method and a system for automatically identifying users and automatically authorizing online payments a merchant websites without requiring any human intervention by the users during the payment transactions.

Reference will now be made in detail to embodiments of the present invention, examples of which are illustrated in the accompanying drawings, wherein like reference numerals refer to like elements throughout. The embodiments are described below in order to explain the present invention by referring to the figures.

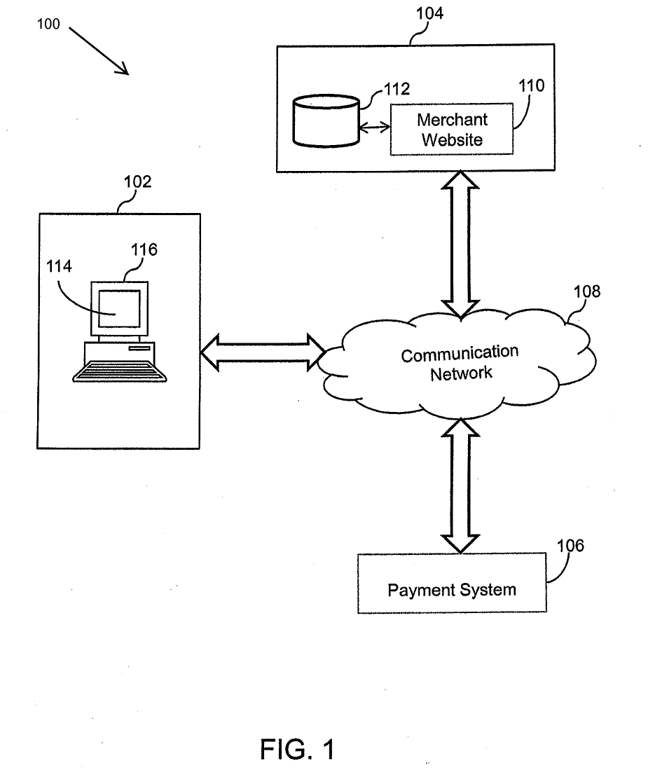

FIG. 1 is a diagram which depicts an embodiment of the system 100 of the present invention. The system 100 comprises a user 102, an online merchant 104 and a payment system 106 that communicate with each other over a communication network 108. The user 102 can be any entity or individual that wishes to purchase products or services from the online merchant 104. The online merchant 104 is preferably an entity that sells goods or services from a merchant website 110, which is implemented using one or more physical servers, also known as web servers 112. As one of ordinary skill in the art will appreciate, a typical website is a collection of related webpages, images, videos or other digital assets that are addressed with a common domain name or IP address in an Internet Protocol(IP)-based network. A website is hosted on at least one web server, accessible via a network such as the Internet or a private local area network. A webpage is a text file that contains not only text, but also a set of HTML tags that describe how the text should be formatted when a browser displays the text on a display screen directed to the website. The tags are simple instructions that tell the Web browser how the webpage should look when displayed. For example, the tags tell the browser to do things like change the font size or color, or arrange things in columns. The Web browser interprets these tags to decide how to format the text onto the screen, webpages are accessed and transported with the Hypertext Transfer Protocol (HTTP), which may optionally employ encryption (HTTP Secure, HTTPS) to provide security and privacy for the user of the webpage content. The user's application, often a web browser, renders the page content according to HTML markup instructions onto a display terminal. (HTML stands for Hyper Text Markup Language, wherein a “markup language” is a computer language that describes how a page should be formatted.)

Returning now to FIG. 1, the online merchant 104 registers the merchant website 110 with the payment system 106 for facilitating online payment. The arrangement between the online merchant 104 and the payment system 106 for facilitating online quick payment without the user having to create a user account on the merchant website 110 may be either a commercial agreement or non-commercial agreement. In order to select and purchase products or services, the user 102 preferably uses a web browser 114 running on a browsing device 116. The browsing device 116 may be any device that can be used to access a website 110 over the Internet, local area network, telecommunication network or any other the communication network 108. Examples of browsing devices 116 include, but are not limited to, laptops, personal desktop computers, mobile phones, PDAs (Personal Digital Assistants) and Internet kiosks. A Web browser 114, like NETSCAPE NAVIGATOR or MICROSOFT INTERNET EXPLORER, is a computer program (also known as a “software application” or simply an “application”) running on a browsing device 116. The Web browser 114 is enabled to go to a web server 112 on the Internet 108 and request a webpage, so that the browser 114 can pull the webpage through the communication network 108 and into the browsing device 116 for display there. Accordingly, a Web browser 114 can interpret the set of HTML tags within the webpage in order to display the webpage of the merchant website 110 on a user's computer screen (i.e. the display screen of the browsing device 116) as the webpage is intended to be displayed.

The web browser 114 displays a plurality of products or services to be purchased. According to an embodiment of the invention, preferable the browsing device 116 used by the user 102 is a laptop. However, the browsing devices 116 that may be used by the user 102 can be any device capable of communicating over the network 108 and interacting with a website 110.

Further, the browsing device 116, web server 112 and the payment system 106 are connected to each other over the Internet as a preferable communication network 108. In another embodiment of the invention, the communication network 108 is a local area network (LAN). In another embodiment, the communication network 108 is a wide area network (WAN). The communication network 108 can be any network through which data packets can be transferred. Further, the communication network 108 can be a combination of different networks that provide communication between the browsing device 116 and the online merchant 104, between the browsing device 116 and the payment system 106, and between the online merchant 104 and the payment system 106.

The Web browser 114 displays a plurality of products or services to be selected for purchase from the website 110. For example, the product displayed may be any item that can be sold and shipped, including consumer products like apparel, cosmetics, electronic goods, etc., or the product could be, for example, instantly displayed and instantly acquired online content like news reports, analysis, share prices, or media on demand, like movies or songs. The user 102 may choose to purchase an item and simultaneously complete payment for same by selecting a provided link corresponding to the item. For example, if the online merchant 104 is an online newspaper provider the user 102 may select a particular piece of news content by clicking on a link. The link follows a reference that activates a web script that sends an authentication request to the browsing device 116 from the merchant website 110. The authentication request comprises relevant data, for example, the cost of the item selected, the digital signature of the website, and other instructions. For example, when the user 102 clicks on a hyperlinked headline of a piece of news, the full news content is available, for example, at a cost of two (2) cents. Selecting the headline sends an authentication request from the browsing device 116 along with the price of the news content.

According to the embodiment, an externally-embedded software code is embedded on merchant website 110. The externally-embedded software code enables merchant website 110 to communicate with both the Web browser 114 and the payment system 106. The externally-embedded software code is a set of instructions understandable by a browsing device 116 which enables web server 112 to send and receive communication messages to and from the web browser 114, thereby encoding and decoding communication messages transferred between the web browser and the web server 112. It would be apparent to a person skilled in the art that the externally-embedded software code may be coded in any of the server-side scripts such as ASP, COLDFUSION MARKUP LANGUAGE, ANSI C, JAVASERVER PAGES, PHP, PERL, SMX, PYTHON, LASSO, RUBY or any other server-side script.

According to an embodiment of the invention, the web browser 114 running on the browsing device 116 connects with the payment system 106 and sends a payment request for processing and verifying the authentication request transmitted by the Web server 112. In the preferred embodiment, the browsing device 116, the web server 112, and the payment system 106 communicate using the hypertext transfer protocol (hereinafter referred as HTTP). HTTP is the principal protocol that web browsers use to communicate with web servers over the Internet. When a web browser follows a hypertext link on a webpage, the browser is said to generate an HTTP request. Associated with each HTTP request is the uniform resource locator, or URL, of the hypertext link. The HTTP request is serviced by a server that handles the URLs within the domain of the server. As HTTP and its related concepts are well known in the art, they will not be discussed in further detail herein. It will be noted that while the use of HTTP is suggested in the preferred embodiment, other communications protocols could be used.

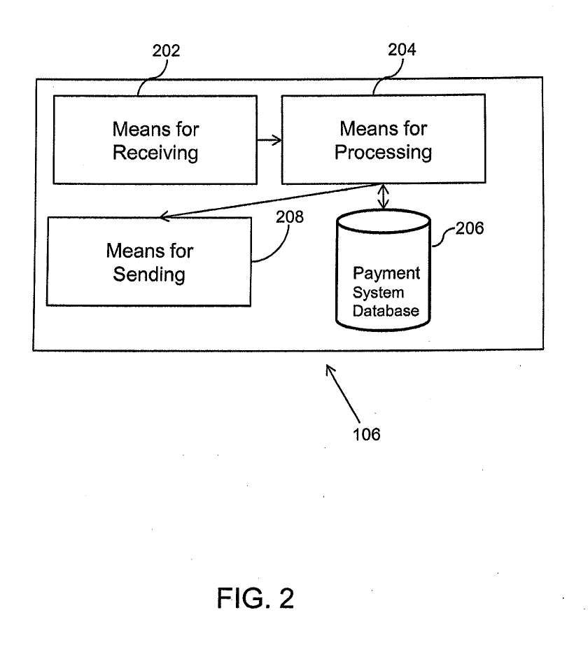

FIG. 2 is a diagram representing the system elements of the payment system 106, according to an embodiment of the invention. In one embodiment, the payment system 106 comprises a means for receiving 202, a means for processing 204, a payment system database 206 and a means for sending 208.

In one embodiment, the means for receiving 202 is a processor enabled to receive a payment request transmitted by the browsing device 116. The payment request is generated and sent by the browsing device 116 in response to the authentication request received by the browsing device 116 from the merchant website 110. The means for receiving 202 may receive the payment request through various transmission protocols, for example, HTTP protocol. The HTTP payment request may contain, for example, cookie information, or an identification cookie associated with the web browser 114 and the price of the item requested. In an embodiment of the invention, an identification cookie for the browsing device 116 is generated by the payment system 106 and stored on the web browser 114 when the web browser 114 communicates for the first time with the payment system 106. The identification cookie comprises parameter values including, but not limited to, the digital signature of the browsing device 116 of the user 102. The identification cookie also may contain a profile of the user 102 and a machine number, or the MAC address, of the browsing device 116.

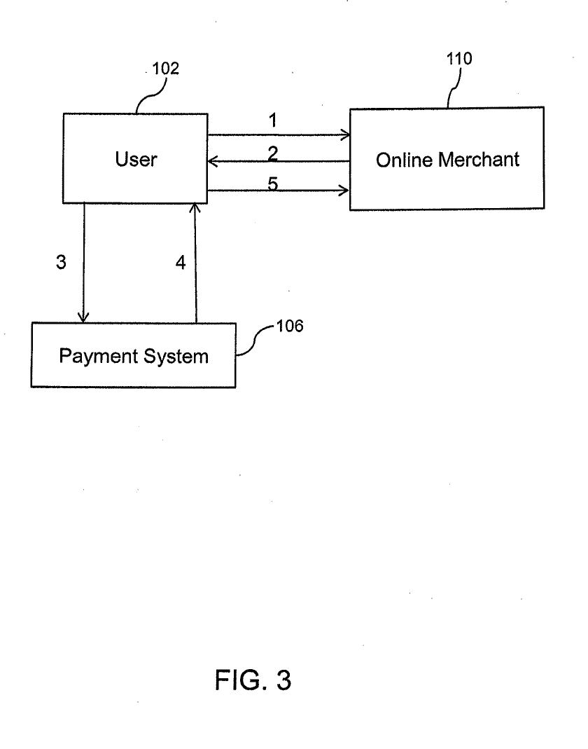

The means for processing 204 is a processor that is enabled to process and authenticate the payment request. The means for processing 204 is a processor that can be any of the commercially available processors including, but not limited to, XEON, AMD AND INTEL processors. The means for processing 204 accesses the user data (e.g. the user profile and MAC address of the browsing device 116) stored in the payment system database 206 for verification and authentication of the payment. The payment system database 206 is enabled to store information about user 102 and the online merchant 104, including a user identification cookie and the digital signatures of the user 102 and the online merchant 104. The means for processing 204 uses the information available in the payment system database 206 to authenticate the user 102 and process the payment request. For example, the means for processing 204 retrieves a user account balance from the payment system database 206 and deducts the cost the item from the user account balance. Details of processing the payment request are discussed in conjunction with FIG. 3.

According to an embodiment of the invention, if the user account balance is insufficient, the user 102 is prompted to charge his account. The details of the charging the account also are discussed in conjunction with FIG. 3.

Payment system 106 also comprises a means for sending 208, an application for instructing the means for processing 204 to transmit a payment response to the web browser 114. The means for sending 208 may send a payment response through various transmission protocols, for example HTTP protocol. The payment response may contain a confirmation approving the payment request, when then is transmitted to the merchant website 110, thereby completing the transaction and enabling the user 102 to access the purchased online content.

FIG. 3 is a diagrammatic representation of the order of the steps in which the method of online payment over the Internet is accomplished according to an embodiment of the invention. Referring to FIG. 3, in step 1, the user 102 enters a website address of a merchant website 110 into the web browser 114 thereby redirecting the display screen of the browsing device 116 to a first webpage of the website 110. For example, the first webpage may be the homepage of a merchant website 110 that presents various items for sale. Here, the web browser 114 may be a computer program, a software application or even mobile based software that is enabled to go to a web server 112 in communication with the Internet 108 and request a webpage hosted by the web server, so that the web browser 114 can pull the webpage through the communication network 108 for display on the browsing device 116. Also, a web browser is enabled to interpret the set of HTML tags within the webpage in order to display the webpage on a display screen of the browsing device 116 as the webpage is intended to be displayed. Typical examples of a web browser 114 include Google Chrome®, Mozilla Firefox®, Microsoft® Internet Explorer ®, and the like.

According to an embodiment of the invention, clicking on a hyperlink for viewing a piece of online content on merchant website 110 prompts web server 108 to transmit the authentication request to the Web browser 114. According to another embodiment, the user 102 may shop online by selecting a picture of the product displayed for sale on the merchant website 110. According to an alternate embodiment, the user 102 may align the visual pointer on the display screen and click a ‘buy’ or ‘view’ button provided alongside the content headline, thereby viewing the complete online content, for example an article on a newspaper website. An externally-embedded software code running on the merchant web server 108 automatically sends an authentication request to the browsing device 116 in step 2 of FIG. 3. This externally-embedded software code, which is essentially a set of instructions in a server side script, is embedded in the merchant website 110 by the payment system 106. The externally-embedded software code initiates the process of authenticating the user 102 authentication for completing the payment process. According to the embodiment, the externally-embedded software code is saved on merchant website 110 by the online merchant 104.

In step 3 of FIG. 3, the web browser 114 running on the browsing device 116 connects with the payment system 106 and sends a payment request for processing and authentication. The payment request also may include, but is not limited to, an identification dataset stored on the browsing device 116. The web browser 114 may send the payment request to the payment system 106 in a JavaScript®, or any other server script, as discussed in conjunction with FIG. 2. The identification dataset is a data packet that may contain information about the user 102, website related data, information about the browsing device 116, or any other related information stored in a retrievable, transmissible data bundle on the browsing device 116. The identification dataset can be used by the payment system 106 to extract any information that may be necessary to identify the user 102, or, moreover, the browsing device 116 associated with a user profile stored in the payment system database 206.

Various web technologies that may be used to construct the identification dataset may be, but are not limited to, the following tools: (1) web browser cookies, which are pieces of text that are stored on a web browser, (2) Local SharedObject, which acts like a browser cookie but which is accessed with an Adobe® Flash Player® browser plugin installed on the browsing device 116, (3) Java Applet, which can access remote data files and send them freely, with a user's permission, to access the remote files using a Java® plugin installed on the web browser 114 of the browsing device 116, (4) Personal client certificate, which may be imported to a browser, Microsoft® Silverlight®, which can use a sandbox for local files, similar to ADOBE FLASH), (5) Microsoft® ActiveX®, which provides full access to a computer 116 after granting permission, (6) Local proxy software (like Norton® Internet Security®, or any other browser plugins made specifically for the identification of the browsing device 116 of the user 102.

In an exemplary embodiment, the identification dataset contained in the payment request is a browser cookie. The browser cookie, hereinafter referred to as identification cookie, will be used to describe the embodiment in detail. The identification cookie is a piece of text that is stored on the web browser 114 of the browsing device 116. The identification cookie may include the digital signature of the website data, the user profile data, the machine address of the browsing device 116 or any other details. Further, in one embodiment, the identification cookie is stored as a permanent cookie. It would be apparent to a person skilled in the art that any other data apart from that mentioned above also can be included in the identification cookie without affecting the novelty of the invention. The payment request may further comprise, apart from the identification cookie, the price of the item requested. In an embodiment of the invention, an identification cookie is generated by the payment system 106 and stored on the web browser 114 when the web browser 114 communicates for the first time with the payment system 106.

The means for processing 204 accesses the user data stored in the payment system database 206 for verification and authentication of the payment, and the payment system database 206 stores information about the user 102 and the merchant 104, including the user identification cookies and digital signatures of the user 102 and the online merchant 104. The means for processing 204 verifies the identification cookie and compares the digital signature of the website 110 against the database records. Once the authenticity of merchant website 110 is confirmed, the means for processing retrieves the account balance of the user account corresponding to the identification cookie, and verifies whether the account balance is sufficient for automatically making the instant payment. In another embodiment of the invention, an overdraft condition is set whereby even if the balance in the user account is insufficient, the payment is allowed with the money being credited in the account. The account of the user 102 is replenished once the user 102 recharges the balance in his account. It is to be noted that the user 102 may recharge his account at any time irrespective of the user account balance and without registering at the payment system 106. The flexibility of charging the account through any of the available online transaction channels like PayPal™, credit card payment, Internet banking (ACH), etc., is available to the user 102 at all times. Following verification of sufficiency of account balance and/or overdraft settings, the means for processing 204 then deducts the cost of the purchased item from the existing account balance and updates the payment system database 206 accordingly.

After processing the payment request, the payment system 106 sends back a payment response to the web browser 114 in step 4 of FIG. 3. The payment response may be, for example, a JavaScript® code that comprises a confirmation approving the payment request. However, any other web server script may be used to send the payment response, as discussed earlier in conjunction with FIG. 2.

In step 5 of FIG. 3, the web browser 114 posts the payment response to the merchant website 110, wherein a post, or “POST”, message is a standard type HTTP request message used to send data to a web server to be processed in a specific way, like by a CGI script. According to an embodiment of the invention, the online content is displayed to the user 102 on the browsing device 116 in response to the payment response received. It may be noted here that the transactions involved in the online payment process occur at the backend of the payment system, between the payment system 106, web browser 114, and merchant web server 108 without any intervention by the user 102. The user 102 remains on the homepage of merchant website 110 throughout the process. The user 102 is not required to provide any login and password for buying the item nor is the user redirected to a validation webpage for validating the purchase prior to finalization of the transaction. The transaction occurs automatically upon selection of the item for purchase.

In another embodiment, in step 5 of FIG. 3, the web browser 114 may send the payment response by ‘GET’ method instead of ‘POST’ method. The ‘GET’ is a standard and the simplest HTTP method. The main function of ‘GET’ is to ask server for the resource. That resource may be a HTML page, a sound file, a picture file (JPEG) etc. However, sending parameters to the server is also a feature of ‘GET’ method where the total number of characters that can be sent is really limited. In the GET method the data sent is appended to the URL, causing it to be available for viewing by other users. Hence, this is not a secure method.

This system 100 is particularly useful when a user 102 has many online accounts and has difficulty recalling each unique username and password associated with each online account established for accessing unique merchant websites 110. Because the transaction occurs automatically, the system 100 further provides the user 102 with an option for reviewing account transactions and requesting a refund for any errant or unwanted transactions posting to his user account stored in the payment system database 208. Furthermore, the system 100 may cap transactions at a certain dollar amount, such as 150 Euros (approximately 200 USD) so that the system becomes particularly attractive to users 102 making low cost purchases. Users often forget their many usernames and passwords established for accessing a plurality of online merchant websites 110. As a security measure against fraudulent purchases, some sites lock users 102 out so that access is impossible following repeated failed attempts at entering a correct combination of a user name and password. Other websites 110 enable a user to request a forgotten user name and/or password, but those systems typically require the creation of a new username and/or new password.

In any scenario, the hassle of recalling a combination of login elements or re-establishing log in elements, far outweighs the benefits of purchasing low cost items and users 102 are often put off from making purchases online when the burden of accessing content exceeds the desire to obtain the content. The present system and method thereby enable a user to avoid such cumbersome, tedious conditions and access content instantly and automatically without having to intervene for making a payment. Furthermore, because the system 100 does not redirect the browsing device 116 of user 102 from the webpage displaying the desired content, online purchases transact seamlessly and automatically from perspective of the user 102 who has been required to do nothing other than make his intended selection.

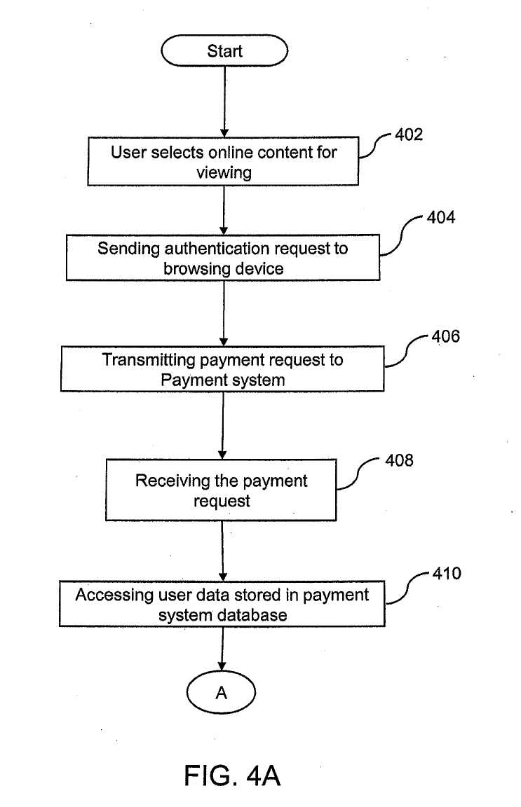

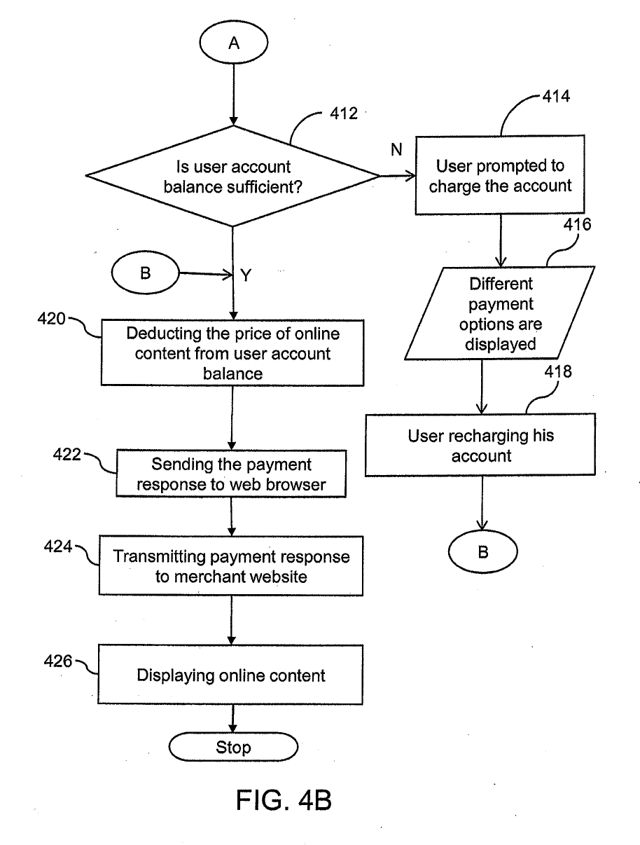

Turning now to FIGS. 4A and 4B, of the present invention comprises a method of use. As discussed above in reference to the system 100, the online merchant 104 is an online content provider, for example, an online newspaper publisher. In step 402, the user 102 selects content, e.g. news content, by clicking on a hyperlinked headline. IN the example of an online newspaper website 110, the full news content is available, for example, at two (2) cents. Clicking the headline sends an authentication request from the web server 112 to the browsing device 116 along with the price of the news content in step 404. According to the embodiment, an externally-embedded software code is embedded on merchant website 110. The externally-embedded software code enables merchant website 110 to communicate with the web browser 114 running on the browsing device 116.

In step 406, the web browser 114 running on the browsing device 116 connects with the payment system 106 and sends a payment request for processing and authentication.

In step 408, the means for receiving 202 receives the payment request from the browsing device 116. The payment request is sent in HTTP protocol, for example, and contains parameters such as, but not limited to, the digital signature of merchant website 110, the cost of the requested content, and the identification cookie containing the embedded user profile, and the machine number (MAC ID) of the browsing device 116. These parameters are then analyzed by the means for processing 204.

In step 410, the means for processing 204 accesses the user data stored in the payment system database 206 for verification and authentication of the payment. Data stored in the payment system database 206 includes information related to the user 102 and the online merchant 104, including the user identification cookie, digital signatures of the user 102 and the online merchant 104, and the user account balance. The means for processing 204 accesses the payment system database 206 to retrieve this information. The means for processing 204 then verifies the identification cookie and digital signature of the website 110 against the database records. Once the authenticity of merchant website 110 is confirmed, the means for processing 204 retrieves the user account balance corresponding to the identification cookie.

In step 412, the means for processing 204 verifies whether the user account balance is sufficient for making the payment. If the account balance is less than a minimum amount, for example, if the news content costs three (3) cents, for example, and the user account balance is one (1) cent, then the means for processing 204 will verify whether an overdraft option is available and, if not, the means for processing will prompt the user 102 to charge the user account balance in step 414. For example, in one embodiment, the means for processing 104 may prompt he user 102 to choose a preferred credit card or online banking option. In an embodiment of the invention, the user 102 is presented with different credit cards and online banking options on the same webpage as the news content in step 416. No user 102 intervention is involved in any of the steps from 404 to step 416. The user 102 stays on the same home webpage that opened in response to clicking on the hyperlinked news headline.

Once the user 102 selects a payment option, the user 102 is navigated to a new web browser window linking the user 102 to a payment gateway or to his preferred online banking website at step 416. The user 102 also may be taken to a payment gateway that again provides him multiple option payments. The user 102 recharges his account balance using his online credit card or online banking details at step 418. It may be noted that the user 102 may recharge or charge his account at any time irrespective of the user account balance without registering at the payment system 106. The flexibility of charging the account through any of the available online transaction channels like PayPal™, credit card payment, Internet banking (ACH), etc., is available to the user 102 at all times.

In the current embodiment, once the user 102 replenishes his account balance, the payment system 106 continues to operate as shown in FIG. 4A. After step 412, if the user account balance is sufficient to make the payment the payment system 106 advances to step 420. At step 420, the means for processing 204 deducts the cost of the online content from the user account balance and updates the user account balance details in the payment system database 206.

After processing the payment request, the payment system 106 sends back a payment confirmation response to the browsing device 116 in step 422. The payment response may be a JavaScript® code that comprises a confirmation approving the payment request. However, as indicated above, any other web server script may be used to send the payment response. In step 424 the web browser 114 posts the payment response to merchant website 110, wherein post, or ‘POST’, message is a standard type HTTP request message, used to send data to the web server 112 to be processed in a specific way, like by a CGI script. After the merchant Web server 108 receives the payment authentication message from the web browser 114, the online content is displayed to the user 102 on the web browser 114 at step 426.

The user 102 thus views the purchased online content without any user intervention because steps 404 to 424 transact automatically at the back end of the system 100 between the payment system 106, the merchant Web server 108 and the Web browser 114 of the browsing device 116 of the user 102.

It may be noted that although the method described above authenticates and approves a user 102 based on the specific identifying dataset stored on the browsing device 116, the above method can be practiced on a different browsing device 116 by obtaining the identifying dataset through an electronic transmission or upload, such as through personal email or upload from a USB flash memory device. Here, for example, the user 102 would retrieve the identifying dataset, such as an identification cookie stored on the user's the web browser 114 and email that identification cookie to an email address of the user 102. The user 102 could then access his email account from a different browsing device 116 and upload his identification cookie for storage on that different browsing device. In another embodiment, the payment system 106 further comprises an identification system (not shown) that stores the identification cookie. The user may then email the identification system from any browsing device 116 and as for the identification cookie, which the web browser 114 would then automatically store. However, this alternate embodiment requires that the user to provide his email ID to the payment system 106.

It should be apparent to a person skilled in the art that system elements used in the invention are well known in the art; hence other known system elements could also be used in the invention for the same purpose without departing from the scope of the invention.

While examples embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. An online payment method for enabling a user to purchase online content without having to enter any user identification information at the time of purchase, wherein the user accesses the online content on a browsing device in communication with a communication network, the online payment method comprising:
a. receiving a payment request at a payment system in communication with the communication network, wherein:
i. the payment request is automatically transmitted from a browsing device of a user in response to the browsing device receiving a content provider authentication request for purchasing selected online content;
ii. the content provider authentication request is prompted by the user requesting selected online content presented on a webpage hosted by an online content provider in communication with the communication network; and
iii. the payment system does not prompt the user to input any identification data;
b. processing the payment request by the payment system; and
c. sending a payment response over the communication network to the browsing device, which is programmed to transmit the payment response to the merchant website, thereby completing the payment transaction and enabling the user to access the purchased online content from the browsing device, wherein steps a through c execute without user intervention and without redirecting the browsing device to any other webpage.

2. The online payment method as recited in claim 1, wherein the online content is requested by clicking a link provided to display the online content.

3. The online payment method as recited in claim 1, wherein the online content is requested by clicking the link for the online content.

4. The online payment method as recited in claim 1, wherein steps a through c are carried out automatically at the back-end of a system comprising at least the browsing device, the payment system and the online content provider.

5. The online payment method as recited in claim 1, wherein in the step of receiving the payment request further comprises receiving an identification cookie permanently stored on the web browser.

6. The online payment method as recited in claim 1, wherein the step of processing the payment request by the payment system further comprises steps of:
a. receiving the payment request from the browsing device;
b. retrieving the user details and the user account balance from a payment system database;
c. authenticating the payment request, wherein authentication is done by comparing the user details with the payment request; and
d. deducting a payment value from the user account balance, wherein payment value is determined from the payment request.

7. The online payment method as recited in claim 1, wherein the payment request sent by the browsing device to the payment system comprises payment related parameters.

8. The online payment method as recited in claim 7, wherein payment related parameters comprises the price of the online content and a digital signature of the online content provider.

9. An online payment method of enabling a user to order an item from a merchant website, wherein the user accesses the merchant website on a browsing device over a the communication network, the online payment method comprising:
a. placing an order at the merchant website, wherein the order is placed by the user through a web browser running on the browsing device;
b. sending an authentication request to the browsing device by the merchant website, wherein the sent authentication request is received by the web browser running on the browsing device;
c. sending a payment request to a payment system, wherein the payment request is sent by the web browser to the payment system for the authentication request received, while the user staying on the merchant website without navigating away from the merchant website;
d. processing the payment request by the payment system;
e. sending a payment response to the web browser by the payment system;
f. transmitting the payment response to the merchant website; and
g. displaying an item response on the browsing device based on the payment response.

10. The online payment method as recited in claim 9, wherein in the step of sending the payment request to the payment system, the payment request includes an identification cookie from the web browser.

11. The online payment method as recited in claim 9, wherein the step of processing the payment request by the payment system further comprises steps of:
a. receiving the payment request from the web browser;
b. retrieving the user details and the user account balance from a the payment system database;
c. authenticating the payment request, wherein authentication is done by comparing the user details with the payment request; and
d. deducting a payment value from the user account balance, wherein payment value is determined from the payment request.

12. The online payment method as recited in claim 11, wherein the user account balance is charged comprising steps of:
a. linking the payment system to a payment gateway; and
b. transferring of funds to the user account balance using the payment gateway, wherein the user uses the payment gateway to transfer the funds.

13. The online payment method as recited in claim 9, wherein the payment request sent by the web browser to the payment system comprises payment related parameters.

14. The online payment method as recited in claim 13, wherein payment related parameters comprises the price of the item and a digital signature of the merchant website.

15. The online payment method as recited in claim 9, wherein the payment request sent by the web browser to the payment system comprises an identification cookie.

16. The online payment method as recited in claim 9, wherein the payment request sent by the web browser to the payment system comprises an identification dataset.

17. The online payment method as recited in claim 16, wherein the identifying dataset is an Adobe LocalSharedObject.

18. A system that enables a user to order an item from a merchant website, wherein the user accesses the merchant website over a communication network, the system comprising:
a. a browsing device, for placing an order at the merchant website through a web browser running on the browsing device;
b. a merchant web server, the merchant web server hosting the merchant website, wherein an authentication request is sent to the web browser running on the browsing device by the merchant website;
c. a payment system, the payment system further comprising:
i. a means for receiving, wherein the means for receiving receives a payment request from the browsing device;
ii. a means for processing the payment request by the payment system;
iii. a payment system database for storing the user details and the user account balance, wherein the means for processing authenticates the payment request and deducting a payment value from the user account balance,
iv. a means for sending, wherein the means for sending sends a payment response to the web browser by the payment system which is further transmitted to the merchant website.

19. The system as recited in claim 18, wherein the payment request sent by the web browser to the payment system comprises digital signature of the website data.

20. The system as recited in claim 18, wherein the payment request sent by the web browser to the payment system comprises an identification cookie.

21. The system as recited in claim 18, wherein the payment request sent by the web browser to the payment system comprises an identification dataset.

22. The system as recited in claim 21, wherein the identifying dataset is an Adobe LocalSharedObject.
